(19) United States
(12) Patent Application Publication
(10) Pub. No.: US 2026/0251907 A1
(43) Pub. Date: Aug. 27, 2026

(54) PERMANENTLY SELF-LUMINOUS SIGHTING ELEMENT

(71) Applicant: smolsys AG, Luzern (CH)

(72) Inventor: Patrick BURKHALTER, Heimiswil (CH)

(73) Assignee: smolsys AG, Luzern (CH)

(21) Appl. No.: 19/551,752

(22) Filed: Feb. 27, 2026

(30) Foreign Application Priority Data
Feb. 27, 2025 (EP) 25160746.1

(51) Int. Cl. G02B 27/20; F21V 9/32; F41G 1/34

(52) U.S. Cl. CPC G02B 27/20; F21V 9/32; F41G 1/345

(57) ABSTRACT

A permanently self-luminous sighting element for marking important points in bright light, poor lighting conditions and in darkness is disclosed. He sighting element includes a cylindrical housing with an axis, a transparent end wall arranged normally thereto as viewing surface, a rear wall arranged opposite thereto, and a liner, which together form an enclosed, gas-impermeable interior space. A cylindrical glass capsule embodied as self-luminous gaseous tritium light source (GTLS) is introduced in the interior space coaxially to the axis, which glass capsule comprises a glass liner surface and a front surface facing the end wall. A pigment layer suffused with persistently phosphorescent pigments and having an end surface facing the end wall is arranged between the glass liner surface and the liner, with the pigment layer and the GTLS belonging to the same colour tone.

### FIELD OF THE INVENTION

The invention relates to a permanently self-luminous sighting element for marking important points in bright light, poor lighting conditions and in darkness, in particular for fitting in sighting instruments.

### BACKGROUND

Self-illuminating or persistently phosphorescent elements are needed mainly in watches, on bezels or in other instruments, in aircraft cockpits for example, to direct attention to the key parts of indicators and inscriptions on the instruments. In this way, the viewer is able to read the instrument settings in low light or darkness. Other examples of use are sighting aids on weapons, known as notch and bead sights. Self-illuminating apparatuses of such kind are not connected to a power supply and are often very small.

Particularly well-known in this context are self-luminous gaseous tritium light sources, also referred to by their English abbreviation GTLS. These are closed glass capsules which are coated on the inside with a phosphor and filled with the mildly radioactive tritium gas. Phosphor is the term used colloquially to describe substances that can be caused to emit light when exposed to radiation. This effect is called fluorescence, in which light emission stops or continues for only a very short time, e.g., a few milliseconds. Examples of such substances are CRT phosphors, which include metal-doped zinc sulphide and zinc oxide, which emit light upon exposure to radioactive radiation.

Radioluminescent capsules of this kind light up because of the long half-life of the tritium gas, about a decade, and have proven highly effective. However, since their permanent luminosity is rather weak, they are not very noticeable in bright light, when they appear white. In twilight, they are only perceived by the human eye after a while, when the eye has grown accustomed to the lighting conditions.

Persistently phosphorescing - also called “phosphorescent” colours are known as alternatives to luminescence, the collective term for cold light phenomena, and are often found on the hands and points of watches and on bezels. They continue to emit light in total darkness spontaneously for a prolonged period, in some cases several hours, entirely due to previously stored energy. These occasionally long-lasting and strong persistently phosphorescent dyes are difficult to apply and must be well protected from environmental influences, particularly moisture. But like other colour pigments, they can also be embedded in plastic materials, for example. They derive their energy from light, daylight for example, to which they must be exposed for a long time so that they can store the energy, which is then released slowly over the long period described above.

Another form of luminescence is the fluorescing glow, known as fluorescence, as is known from highlighters. The molecules contained in these substances absorb UV radiation and emit the energy gained in this way immediately, after less than a microsecond, in the form of visible light. Consequently, in daylight they glow more brightly than the surrounding area, but in darkness they do not light up at all. The do not contain any persistently phosphorescent pigments, which can store light for minutes or even hours. These substances can easily be incorporated in plastics, particularly plexiglas.

A GTLS that is combined with persistently phosphorescent pigments is known WO 2028/137918. A layer of persistently phosphorescent pigments is arranged between the viewing surface and a GTLS, so that the viewer looking through this surface in twilight initially sees mainly the bright persistently phosphorescent pigments, and after a while, as the eye slowly becomes accustomed to the darkness, sees the GTLS more clearly, while the luminosity of the persistently phosphorescent pigments gradually diminishes. These solutions are highly valued, particularly in the cockpit where it is important to be able to locate the point quickly, in the event of a sudden power failure, for example.

Notch and bead sights are used for sighting firearms, for example. The bead is the part of the sighting device located close to the muzzle. Self-illuminating or persistently phosphorescent reference points can be used in these too. It has been found that the combination described above of self- and persistently phosphorescent reference points does not produce satisfactory results for all applications. In some visibility conditions, the point is too harsh, so it appears fuzzy and lacks definition.

A sighting device is known from US 20130097881A1 that includes a self-luminous light source and a light-guiding and/or light-collecting material that surrounds the light source in the form of a tube. The ambient light that penetrates the liner surfaces of the tube is collected and concentrated in a bundle and delivered at the end surface. Fluorescing molecules may also be embedded in the material of the tube, which may be excited by light. However, this effect disappears in twilight and darkness.

### SUMMARY OF THE INVENTION

It is an object of the present invention to describe a permanently self-luminous sighting element of the kind discussed above, which is perceived even in low lighting conditions as a defined point and not as a diffusely radiating point. At the same time, brightness alone is not the decisive factor.

According to one embodiment of the invention the sighting element comprises a cylindrical housing with an axis and a transparent end wall arranged normally thereto as a viewing surface. It further comprises a rear wall arranged opposite said end wall and a liner. The end wall, the rear wall and liner together form an enclosed interior space.

In this interior space, a cylindrical glass capsule embodied as a self-luminous gaseous tritium light source GTLS is introduced coaxially with the axis, comprising a glass liner surface and a front surface facing the end wall. The glass capsule is also referred to as GTLS here. According to the invention, a pigment layer suffused with persistently phosphorescent pigments is arranged or applied between the glass liner surface of the glass capsule and the liner of the housing and has an end surface facing the end wall. Most importantly, there is no layer with persistently phosphorescent pigments arranged between the front surface and the end wall, so a viewer looking axially towards the end wall has an unobstructed view through the end wall to the front surface of the glass capsule of the GTLS and the end surface of the pigment layer present in the GTLS.

It has been found that the outer, radial edge of the luminous point created by the GTLS is defined more clearly by the delimiting surround of the persistently phosphorescent pigments in the pigment layer, as this prevents light from escaping laterally. According to the invention, it is advantageous if the colours of the GTLS and of the pigments are as similar as possible, so that the point is perceived as an optical unity.

Surprisingly, said pigment layer only has to be very thin to fulfil this purpose, for example between 0.1 and 0.3 mm, ideally about 0.2 mm. Substances containing strontium aluminate (SrAl2O4), zinc sulphide (ZnS), brand names LumiNova® from Nemoto & Co., Ltd (JP) and/or Super-LumiNova® from LumiNova AG (CH) are preferably used as pigments.

Further preferred variants are disclosed herein.

### BRIEF DESCRIPTION OF THE DRAWINGS

In the following disclosure, the invention will be represented in various drawings and explained in greater detail with the aid of the reference numerals listed afterwards. In all cases, the same numerals refer to the same elements.

In the drawing:

FIG. 1 is a simple diagrammatic representation of a sighting element according to the invention;

FIG. 2 shows a sighting element with a lens;

FIG. 3A shows a sighting element encased in a potting compound;

FIG. 3B shows a sighting element with the potting compound as pigment layer;

FIG. 4 shows a sighting element with rear wall mounted;

FIG. 5 shows a sighting element with liner coated on the inside;

FIG. 6 shows a sighting element with a transparent section in the liner;

FIG. 7 shows a sighting element with a plastic sleeve; and

FIG. 8 shows the apparatus of FIG. 7 as seen by a viewer.

### WAYS OF IMPLEMENTING THE INVENTION

In the following, the terms “front” or “front region” refer to the area in region of the end wall of the sighting element, also called the “end region”, while the terms “back” or “rear region” refer to the area around the rear wall of the sighting element.

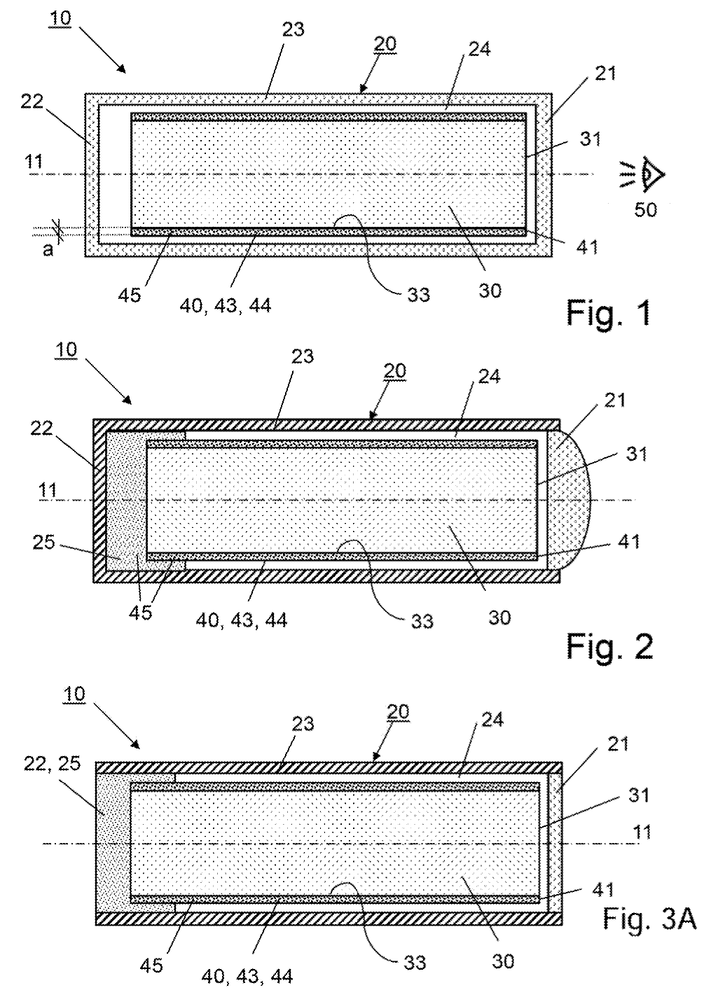

FIG. 1 is a simple diagrammatic representation of a permanently self-luminous sighting element 10 according to the invention. It is used to mark important points in bright light, poor lighting conditions and in darkness. In particular, it can be used for installation in aiming instruments.

The sighting element 10 comprises a cylindrical housing 20 with an axis 11, a transparent end wall 21 arranged normally thereto as a viewing surface, a rear wall 22 arranged opposite thereto, and a liner 23, which together form a closed, gas-impermeable interior space 24. In this interior space 24, a cylindrical glass capsule 30 embodied as a self-luminous gaseous tritium light source GTLS is introduced coaxially with the axis 11. The glass capsule 30 comprises a glass liner surface 33 and a front surface 31 facing the end wall 21.

A pigment layer 40 suffused with persistently phosphorescent pigments 45 is arranged or applied between the glass liner surface 33 of the glass capsule 30 and the liner 23 of the housing 20. It has an end surface 41 facing the end wall 21. Said end surface is in the form of a circular disc and borders the GTLS in the direction of the end wall. Said pigment layer may in particular be bonded in an adhesive.

According to the invention, there is no layer with persistently phosphorescent pigment arranged between the front surface 31 and the end wall 21, so a viewer 50 looking axially at the end wall 21 has an unobstructed view through the end wall 21 to the front surface 31 of the glass capsule 30 and the end surface 41 of the pigment layer 40.

In this illustration, the housing 20 is represented as being made as a single part from a homogeneous material and transparent. When it is constructed, however, the housing 20 will consist of several components. This is not shown in greater detail in FIG. 1. In general, the liner 23 may be made at least partly from metal, plastic, glass, sapphire glass or ceramic.

A sighting element 10 should at least not emit light from the rear, so that the user is not seen. But since a sighting element 10 is typically fitted in an apparatus of which only the front and at most an upper region are visible in the liner 23, a transparent housing 20 is not a problem during use. Similarly, a transparent and visible rear wall 22 does not present any difficulties for sport shooting.

According to the invention, the colours of the self-luminous glass capsule 30 and the persistently phosphorescent pigments 45 are similar, they should at least belong to the same colour tone. This enables them to reinforce each other in their visual appearance and to form an optical unity for the viewer. The circular disc-shaped surround of the GTLS 30 with the end surface 41 suffused with the pigments 45 serves to accentuate the border of the GTLS 30, which in turn enhances the sharpness of the luminous point produced thereby. This is important because the viewer 50 is focusing his eyes on a distant aiming point and not on the luminous point created by the GTLS 30. The luminous point created should therefore be as small as possible but clearly visible and not dazzle.

For this purpose, the pigment layer 40 has a radial width a that is very thin. It is preferably between 0.1 and 0.3 mm, ideally 0.2 mm. But a positive effect can be achieved with radial widths as thin as 0.05 mm. Greater widths up to 1 mm are also worthwhile, but radial widths of these or larger dimensions can scarcely be fitted due to space constraints. A GTLS is typically 4.5 mm long with a diameter of 1.25 mm. The construction of the housing 20 is correspondingly as small as possible.

Photoluminescences comprising strontium aluminate SrAl2O4, zinc sulphide ZnS, LumiNova^{®} and/or SuperLumiNova^{®} are used for preference as persistently phosphorescent pigments 45. Other photoluminescences are also suitable, providing they have a long persistence time. For example, Super-LumiNova^{®} continues to glow for about 12 hours.

FIG. 2 represents another design of a sighting element 10. Here, the end wall 21 is embodied as a separate structure that is placed in or on a front region of the liner 23, and then affixed therein or thereon, preferably adhesively. Fixing by pressing in or friction welding is also possible. The liner 23 of the housing 20 in this example is made from non-transparent material. Since the end wall 21 is inserted, the GTLS 30 and the pigment layer 40 can be introduced into the open housing 20 before the interior space 24 is sealed with end wall 21.

The end wall 21 may be flat or it may be designed with a convex or concave surface to form a lens 21, wherein curved surfaces may be formed inside and/or outside. In FIG. 2, the outers surface of the lens 21 is shown to be convex, other examples are not illustrated here. The effect of a lens 21 is to bundle the luminous point produced by the GTLS 30 and optimise it to the desired distance. The sighting element can be optimised for use in the bead of a given certain weapon, as the distance from the bead to the viewer’s eye 50 is known and constant. A flat end wall 21 is also possible and is often preferred.

The end wall 21 may be manufactured in particular from glass, sapphire glass or plastic. This also applies for the other components of the housing 20, the rear wall 22 and the liner 23. On the other hand, these components may also be made of non-transparent material such as metal, ceramic or non-transparent glass or plastic.

In order to affix the GTLS 30, the rear region of the interior space 24 may be filled with a potting compound 25, into which the GTLS 30 is pressed. The potting compound 25 then spreads around the rear part of the GTLS 30. In particular, the potting compound 25 may also contain pigments 45 and/or be suffused with adhesive. With regard to the potting compound 25, the same material may be used as the material from which the pigment layer 40 is made. It is even possible to add a larger quantity of the potting compound 25 of the pigment layer 40 material to the interior space 24, so that after the pressing in excess material oozes out of the housing 20, which is open at the front, which is removed, and the front surface 31 is cleaned of pigments 45 before the end wall 21 is affixed on or in the liner 23 as described above. In this process, the GTLS 30 may come into contact with the end wall 21 but does not have to. In this variant, a further pigment layer 45 does not need to be applied because the potting compound 25 replaces it completely.

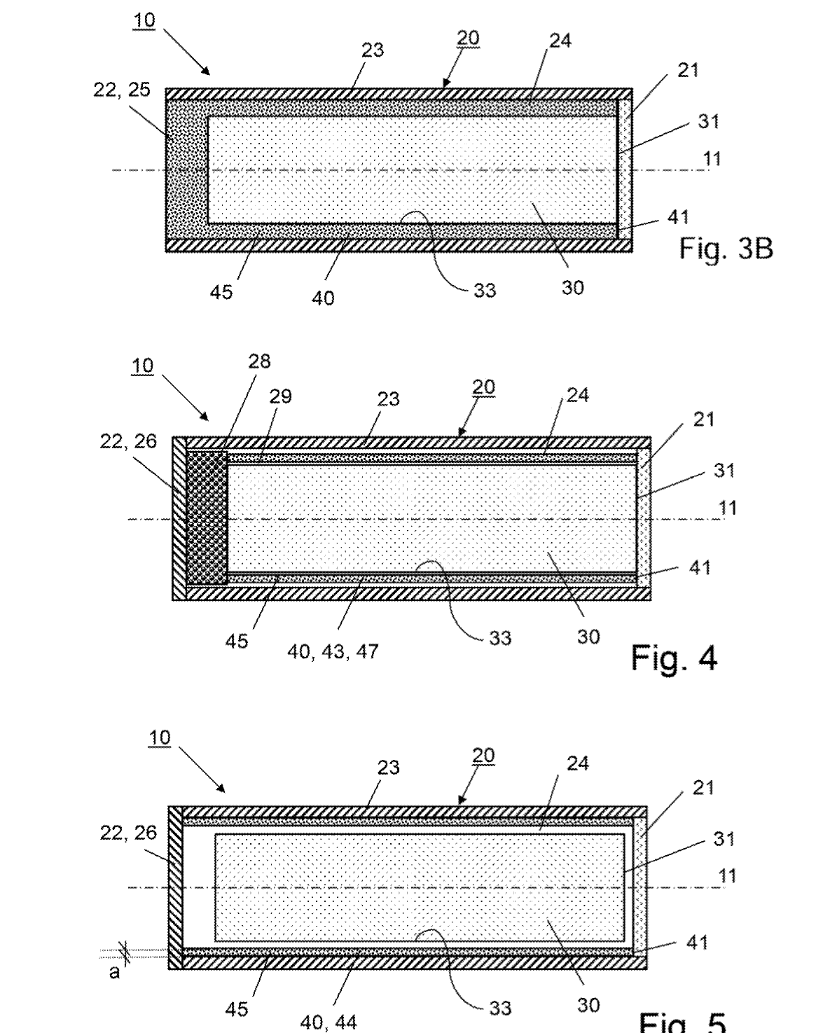

FIG. 3A represents a further variant. Here, the rear wall 22 is created from the potting compound 2 by which the glass capsule 30 is supported in fixed and shock-proof manner in the gas-tight interior space 24. The same potting compound 25 as was described in FIG. 2 may be used, or another that contains no pigments. In order to produce such a sighting element 10, first the end wall 21 may be inserted and fixed in the liner 23, which is open on both sides, before the GTLS 30 and the pigment layer 40 are introduced into the interior space 24. Then, for example, a drop of this potting compound 25 is applied to the rear opening of the liner 23, where a rear wall 22 is to be formed. This potting compound 25 seeps a little into the gap 29 between the liner 23 and the glass liner surface 33 by capillary action or is pressed into it, which in turn fixes the GTLS 30 firmly in place as well. It also fills the space behind the GTLS 30 as far as the end of the liner 23. The potting compound 25 should be resistant to environmental influences, it can be an adhesive. If it is suffused with pigments 45, only those pigments 45 that are exposed directly to the surrounding environment decompose.

Alternatively, the potting compound 25 may be introduced into a rear region of a liner 23 that is open on both sides, and in which the GTLS 30 and the pigment layer 40 are already present or are introduced from the other side. This allows the air in the interior space 24 to escape before the end wall 21 is affixed to the liner 23 and seals the interior space 24 in gas-tight manner. Here too, the potting compound 25 forms the rear wall 22. And the user of a greater quantity of the potting compound 25 is also possible so that it replaces the pigment layer 40 as described in FIG. 2, if the same material that makes up the pigment layer 40 is also used as potting compound 25. Such a variant is represented in FIG. 3B.

FIG. 4 represents a further variant of the sighting element 10. In this case, the rear wall 22 is attached to the liner 23 as component 26, preferably bonded with an adhesive or affixed by friction welding. Here too, the glass capsule 30 and the pigment layer are sealed in gas-tight manner in the interior space 24. In order to affix the GTLS 30, an elastic substance 28 may be introduced between the component 26 and the glass capsule 30 to press the front surface 31 of the glass capsule 30 against the end wall 21.

The pigment layer 40 may be embodied in particular as a tube or sleeve 43 that was placed around the glass capsule 30 before the capsule is introduced into the interior space 24. This may allow a small gap 29 to form between the GTLS 30 and the pigment layer 40, but this is not significant. The tube or sleeve 43 may also lie flush against the glass liner surface 33. They may also be affixed to the liner of the GTLS 30, with a small spot of adhesive for example. It is also possible to clamp them between the end wall 21 and the elastic substance 28, as shown in FIG. 4.

Alternatively, the pigment layer 40 may be spread as coating 44 on the inside of the liner 23 in the interior space 24, as represented in FIG. 5, or on the outside of the glass liner surface 33, as in FIGS. 1 to 3A or 6 for example.

In the examples according to FIGS. 4 and 5, the end surface 41 of the pigment layer 40 reaches as far as the end wall 21, but the viewer 50 does not look through this pigment layer 40 to see the GTLS 30, because the end surface 41 is always beside the front surface 31 of the GTLS. There is never a pigment layer 40, and accordingly never any pigments 45 between the end wall 21 and the front surface 31.

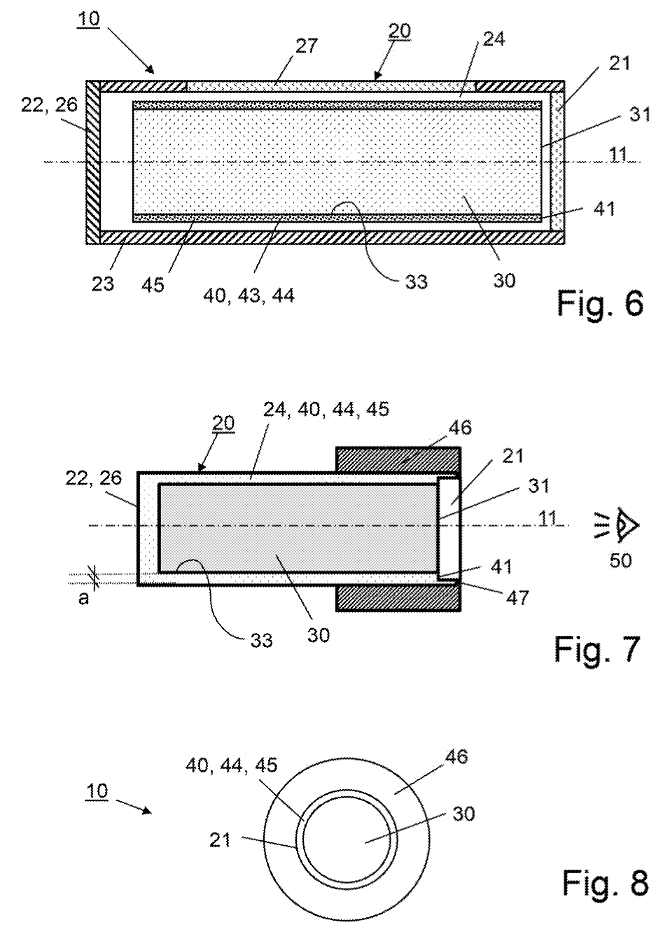

Finally, FIG. 6 represents a variant in which the sighting element 10 includes a transparent section 27 in the liner 23 of the housing 20 to allow light to enter and activate the persistently phosphorescent pigments 45, as was also the case in the design according to FIG. 1. For this purpose, for example the entire liner 23 may be made from transparent material such as glass, sapphire glass or plastic. Then, a part of the liner 23 can be covered, if necessary, for example by applying a coloured layer, in particular black. The light incidence occurs through the transparent end wall 21 in all variants.

The features described in the various figures may be combined freely, not all possible combinations are described in this document. For example, the pigment layer 40 in FIGS. 1 to 3A and 6 may be embodied either as a tube or sleeve 43 or as a coating 44. In these variants, the inside of the liner 23 may also be furnished with a coating 44 instead. The potting compound 25 may be combined with a lens 21, and a transparent section 27 in the liner 23 can also be combined with all other features. This list is not exhaustive.

FIG. 7 represents a sighting element 10 in which a non-transparent, preferably white or coloured plastic sleeve 46, surrounds the housing 20 in the end region. This allows an unobstructed view of the front surface 31 of the GTLS 30 and at least part of the end surface 41 of the pigment layer 40. This plastic sleeve 46 is clearly visible because of its white or coloured appearance, even in twilight. This means that the GTLS 30 located in the middle can be located more quickly and more easily than if one were looking for the typically very small GTLS 30 on its own.

The plastic sleeve 46 preferably has a ridge 47 in the front region thereof, preferably towards the lens 21, which ridge abuts with the housing 20. This enables the plastic sleeve 46 to be pushed over the housing 20 from the end side until it rests against said ridge 47. In this case, the width a of the coating 44 with the persistently phosphorescent pigments 45 may be correspondingly wider. The plastic sleeve 46 may preferably be affixed adhesively to the housing 20.

The housing 20 may also comprise a casing that completely surrounds it, made from aluminium, for example, wherein only the front surface 31 of the GTLS 30 and the end surface 41 of the pigment layer 40 are not surrounded by the casing. Light then passes through the lens 21 either directly or through the GTLS 30 into the pigment layer 40 in which it is stored.

In order to enable the GTLS to be identified quickly, the plastic sleeve 46 may be relatively large. Its outer diameter at the end side is preferably at least twice as large, preferably about three times as large as its inner diameter.

FIG. 8 shows the frontal view of a preferred embodiment of a sighting element 10. The GTLS 30 is arranged in the middle of the sighting element 10, surrounded concentrically by the pigment layer 40 with the persistently phosphorescent pigments 45. For the viewer 50, these two luminous surfaces 30, 40 are visible through the lens 21. The plastic sleeve 46 is arranged around the frontal side of the lens 21. The ridge 47 forms an internal ring of the plastic sleeve 46, although this is not identifiable as such by the viewer 50, because it is designed to be level with the rest of the plastic sleeve 46 at the end side.

The small surface of the GTLS 30 has an approximate diameter of just 1-3 mm, it is typically 1.2 mm. It is accentuated by the layer 40 of persistently phosphorescent pigments, which appears as a ring having the same colour tone as the GTLS 30.

The plastic sleeve 46 serves to make the GTLS easy to find even in daylight, as the plastic sleeve 46 Is white or another, preferably bright, colour. For example, if the GTLS 30 has a diameter of 1.2 mm and a pigment layer 40 has a diameter of 0.2 mm, the wall thickness of the plastic sleeve 46 at the end side is about 1.6 mm, so in this case the overall diameter at the end side is about 4.8 mm.

### LIST OF REFERENCE NUMERALS

10 Sighting element

11 Axis

20 Housing

21 End wall, lens

22 Rear wall

23 Liner

24 Interior space

25 Potting compound

26 Component (as rear wall)

27 Transparent section

28 Elastic body

29 Gap

30 Glass capsule, GTLS

31 Front surface

33 Glass liner surface

40 Pigment layer

41 End surface

43 Tube or sleeve

44 Coating

45 Pigment, persistently phosphorescent

46 Plastic sleeve

47 Ridge in the plastic sleeve

50 Viewer, viewer’s eye

a Width

1. A permanently self-luminous sighting element for marking important points in bright light, poor lighting conditions and in darkness, the sighting element comprising:
a cylindrical housing with an axis, a transparent end wall arranged normally thereto as a viewing surface, a rear wall arranged opposite thereto, and a liner, which together form an enclosed, gas-impermeable interior space,
wherein a cylindrical glass capsule embodied as self-luminous gaseous tritium light source (GTLS) is introduced in the interior space coaxially to the axis, which glass capsule comprises a glass liner surface and a front surface facing the end wall,
wherein a pigment layer suffused with persistently phosphorescent pigments and having an end surface facing the end wall is arranged or applied between the glass liner surface of the glass capsule and the liner, and
wherein no layer with persistently phosphorescent pigments is arranged between the front surface and the end wall, so a viewer who looks axially towards the end wall has an unobstructed view through the end wall to the front surface of the glass capsule and the end surface of the pigment layer,
wherein colours of the self-luminous GTLS and the persistently phosphorescent pigments are similar to each other and belong to the same colour tone in order to reinforce each other in appearance and to form an optical unit.

2. The sighting element according to claim 1, wherein the persistently phosphorescent pigments are photoluminescences, preferably comprising at least one of strontium aluminate, zinc sulphide, LumiNova^{®} and Super-LumiNova^{®}.

3. The sighting element according to claim 1, wherein the end wall is mounted in or on an end region of the liner and affixed thereto, preferably by pressing in, welding or adhesion.

4. The sighting element according to claim 1, wherein the end wall is designed to be flat or with a convex or concave surface to form a lens.

5. The sighting element according to claim 1, wherein the end wall is made from glass, sapphire glass or plastic.

6. The sighting element according to claim 1, wherein the rear wall is produced from a potting compound, by which the glass capsule is supported in fixed and shock-proof manner in the gas-tight interior space.

7. The sighting element according to claim 1, wherein the rear wall is attached, preferably affixed adhesively, as a component to the liner, so that the glass capsule is sealed in gas-impermeable manner in the interior space.

8. The sighting element according to claim 1, wherein the pigment layer is embodied as a tube or sleeve and lies flush or with a small gap around the glass capsule.

9. The sighting element according to claim 1, wherein the pigment layer is applied as coating to the inside of the liner or to the outside of the glass liner surface in the interior space.

10. The sighting element according to claim 1, wherein the pigment layer has a radial width from 0.1 to 0.3 mm.

11. The sighting element according to claim 1, wherein the liner has a transparent section to enable incidence of light to activate the persistently phosphorescent pigments.

12. The sighting element according to claim 1, wherein the liner is made at least partly of metal, plastic, glass, sapphire glass or ceramic.

13. The sighting element according to claim 1, wherein a non-transparent, preferably white or coloured plastic sleeve surrounds the housing in the end region, which allows unobstructed view of the front surface of the GTLS and at least part of the end surface of the pigment layer.

14. The sighting element according to claim 13, wherein the plastic sleeve has a ridge in the end region, which ridge abuts with the housing, wherein the plastic sleeve is preferably affixed adhesively to the housing.

15. The sighting element according to claim 13, wherein the ratio of the outer diameter to the inner diameter of the plastic sleeve in the end region is at least 2:1, preferably 3:1.
